(19) United States
(12) Patent Application Publication
(10) Pub. No.: US 2020/0065330 A1
(43) Pub. Date: Feb. 27, 2020

(54) XML Data Manipulation Method and Apparatus

(71) Applicant: Kmerit (Suzhou) Information Science & Technology Co., Ltd., Suzhou, Jiangsu (CN)

(72) Inventor: Jinyun Zhang, Suzhou (CN)

(73) Assignee: Kmerit (Suzhou) Information Science & Technology Co., Ltd., Suzhou, Jiangsu (CN)

(21) Appl. No.: 16/346,408

(22) PCT Filed: Sep. 21, 2017
(86) PCT No.: PCT/CN2017/102568

§ 371 Date: Apr. 30, 2019

(30) Foreign Application Priority Data
Oct. 31, 2016 (CN) 201610929816.1

(51) Int. Cl. G06F 16/835; G06F 16/84; G06F 16/838; G06F 16/2453

(52) U.S. Cl. CPC G06F 16/8358; G06F 16/24534; G06F 16/838; G06F 16/86

(57) ABSTRACT

An XML data manipulation method and apparatus, belonging to the field of data processing. The method comprises: obtaining a structured query language (SQL) manipulation instruction for extensible markup language (XML) data, and checking the SQL manipulation instruction (101); if checking is successful, recognizing the SQL manipulation instruction, and recognizing conditions included in the SQL manipulation instruction (102); transforming a keyword in the SQL manipulation instruction into an XML statement, and transforming the conditions included in the SQL manipulation instruction into XML conditions (103); and manipulating the XML data according to the XML statement and the XML conditions, and returning a manipulation result (104). Thus, by transforming a keyword in an SQL manipulation instruction into an XML statement, transforming the conditions included in the SQL manipulation instruction into XML conditions, and manipulating XML data according to the XML statement and the XML conditions, manipulation of the data in an XML format by means of the SQL is realized, so that data stored in the XML format can be conveniently and rapidly manipulated, thereby improving the efficiency of data manipulation and facilitating use for a user.

### TECHNICAL FIELD

The present disclosure relates to the field of data processing, and in particular, to a method and an apparatus of manipulating XML data.

### BACKGROUND

Extensible Markup Language (XML) is designed to structure, store, and transfer information. XML is increasingly favored by people because of its convenience, and people are becoming more and more accustomed to storing data in XML format. However, because the existing execution mechanism of the XML file manipulation instruction is complicated, and the compatibility is poor as it is incompatible with many data scenarios, it reduces the efficiency of the data manipulation after the user saved the data in the XML format.

Structured Query Language (SQL) is the most widely used language in relational database systems. SQL is easy to learn, having good compatibility, and is convenient and fast for data manipulation. However, XML data cannot be manipulated by using SQL, so there is a need to provide a method to manipulate XML data by using SQL.

### SUMMARY

In order to implement the manipulation on data in XML format by SQL, to improve data manipulation efficiency and to facilitate the use of users, the embodiments of the present disclosure provide a method and an apparatus for manipulating XML data. The technical solutions are as following.

In a first aspect, a method of manipulating XML data is provided. The method includes: obtaining SQL manipulation instructions for XML data, and verifying the SQL manipulation instructions;

when verification is successful, identifying the SQL manipulation instructions, and identifying conditions contained in the SQL manipulation instructions;

converting keywords in the SQL manipulation instructions into XML statements, and converting the conditions contained in the SQL manipulation instructions into XML conditions; and

manipulating the XML data, according to the XML statements and the XML conditions, manipulating and returning manipulation results.

In conjunction with the first aspect, in a first possible implementation manner, verifying the SQL manipulation instructions includes:

verifying, according to a grammar engine, whether the SQL manipulation instructions conform to standard SQL manipulation instructions.

In conjunction with the first aspect or the first possible implementation manner of the first aspect, in a second possible implementation manner, identifying the SQL manipulation instructions includes:

identifying manipulation types of the SQL manipulation instructions;

identifying, according to the manipulation types, keywords corresponding to each of the manipulation types; and

performing non-sensitive process on the keywords.

In conjunction with the first aspect or the first possible implementation manner of the first aspect, in a third possible implementation manner, identifying the conditions contained in the SQL manipulation instructions include:

determining whether conditional statements exist in the SQL manipulation instructions;

when the conditional statements exist, transforming the conditional statements into Reverse Polish Notations; and

when the conditional statements do not exist, setting the conditional statement to a default value.

In conjunction with the third possible implementation manner of the first aspect, in a fourth possible implementation manner, the SQL manipulation instructions contain the conditional statements, and converting the conditions of the SQL manipulation instructions into XML conditions includes:

converting the Reverse Polish Notations into XML conditions.

In conjunction with the first aspect, in a fifth possible implementation manner, manipulating the XML data according to the XML statements and the XML conditions manipulating and returning manipulation results includes:

obtaining manipulation destination data from the XML data according to the XML conditions;

manipulating the manipulation destination data according to the XML statements, and returning manipulation results.

In a second aspect, an electronic apparatus is provided. The apparatus includes:

an SQL manipulation instruction obtaining module, configured to obtain SQL manipulation instructions for XML data;

a verification module, configured to verify the SQL manipulation instructions;

an identification module, configured to identify the SQL manipulation instructions and to identify conditions contained in the SQL manipulation instructions, when the verification module is successfully verified;

a keyword conversion module, configured to convert keywords in the SQL manipulation instructions into XML statements;

a condition conversion module, configured to convert the conditions contained in the SQL manipulation instructions into XML conditions; and

an XML data manipulation module, configured to manipulate the XML data according to the XML statements and the XML conditions, and to return manipulation results.

In conjunction with the second aspect, in a first possible implementation manner, the verification module is specifically configured to:

verify, according to a grammar engine, whether the SQL manipulation instructions conform to standard SQL manipulation instructions.

In conjunction with the second aspect or the first possible implementation manner of the second aspect, in a second possible implementation manner, the identification module includes:

a manipulation type identification sub-module, configured to identify manipulation types of the SQL manipulation instructions;

a keyword identification sub-module, configured to identify, according to the manipulation types, keywords corresponding to each of the manipulation types; and

a non-sensitive processing sub-module, configured to perform non-sensitive process on the keywords.

In conjunction with the second aspect or the first possible implementation manner of the second aspect, in a third possible implementation manner, the identification module further includes:

a conditional statement determining sub-module, configured to determine whether conditional statements exist in the SQL manipulation instructions;

an RPN conversion sub-module, configured to transform the conditional statements into Reverse Polish Notations, when the conditional statement determining sub-module determines that the conditional statements exist in the SQL manipulation instructions; and

a default value setting sub-module, configured to set the conditional statement to a default value, when the conditional statement determining sub-module determines that the conditional statements do not exist in the SQL manipulation instructions.

In conjunction with the third possible implementation manner of the second aspect, in a fourth possible implementation manner, the SQL manipulation instructions contain the conditional statements, and the condition conversion module is specifically configured to:

convert the Reverse Polish Notations into XML conditions.

In conjunction with the second aspect, in a fifth possible implementation manner, the XML data manipulation module includes:

a destination data obtaining sub-module, configured to obtain the manipulation destination data from the XML according to the XML condition;

a destination data manipulation sub-module, configured to manipulate the manipulation destination data according to the XML statements, and to return manipulation results.

The beneficial effects of the technical solutions provided by the embodiments of the present disclosure are as following. By converting keywords in the SQL manipulation instructions into XML statements, converting conditions contained in the SQL manipulation instructions into XML conditions, manipulating XML data according to the XML statements and the XML conditions and returning the manipulation results, it is possible to manipulate manipulation data in XML format by SQL, and the data stored in XML format can be manipulated conveniently and quickly, improving data manipulation efficiency and facilitating the use of users. As SQL is widely used in relational database systems, and more and more data are stored in XML format because of the convenience of XML format data, by the method provided by the embodiments of the present disclosure, it is possible to manipulate data stored in XML format by SQL, solving the problem of having to manipulate the XML format data in some SQL-used databases. Meanwhile, by identifying the SQL manipulation instructions, identifying the conditions contained in the SQL manipulation instructions, converting the keywords in the SQL manipulation instructions into XML statements, and converting the conditions contained in the SQL manipulation instructions into XML conditions, the manipulation is convenient and quick, and it is possible to manipulate the XML format data by SQL quickly, improving manipulation efficiency and facilitating the use of user. Meanwhile, the embodiments of the present disclosure perform verification on the SQL manipulation instructions before identifying the SQL manipulation instructions and identifying the conditions contained in the SQL manipulation instructions. The verification makes the SQL manipulation instructions conform to the standard SQL instructions, avoiding the problem of lower manipulation efficiency and repeated manipulations caused by the execution error by non-standardized instructions. Thereby data manipulation efficiency is provided, and the use of users is facilitated.

### BRIEF DESCRIPTION OF THE DRAWINGS

In order to make a clearer explanation for the technical solutions of the embodiments of the present disclosure, the drawings used in the description of the embodiments are briefly described below. Obviously, the drawings described below are only some embodiments of the present disclosure, and a person of ordinary skill in the art can obtain other drawings according to these drawings without creative effort.

FIG. 1 is a flow chart of a method for manipulating XML data provided by an embodiment of the present disclosure.

FIG. 2 is a flow chart of a method for manipulating XML data provided by an embodiment of the present disclosure.

FIG. 2-1 is a schematic diagram of a text flow diagram of converting SQL manipulation instructions into XML statements provided by an embodiment of the present disclosure.

FIG. 3 is a schematic diagram of the structure of an electronic apparatus provided by an embodiment of the present disclosure.

### DETAILED DESCRIPTION

In order to clarify the destination, the technical solutions and the merit of the present disclosure, the technical solutions in the embodiments of the present disclosure are clearly and completely described below in conjunction with drawings in the embodiments of the present disclosure. Obviously, the embodiments described are only some of the embodiments of the present disclosure, and not all of the embodiments. All other embodiments obtained by a person of ordinary skill in the art based on the embodiments in the present disclosure without creative efforts are within the scope of the present disclosure.

### Embodiment 1

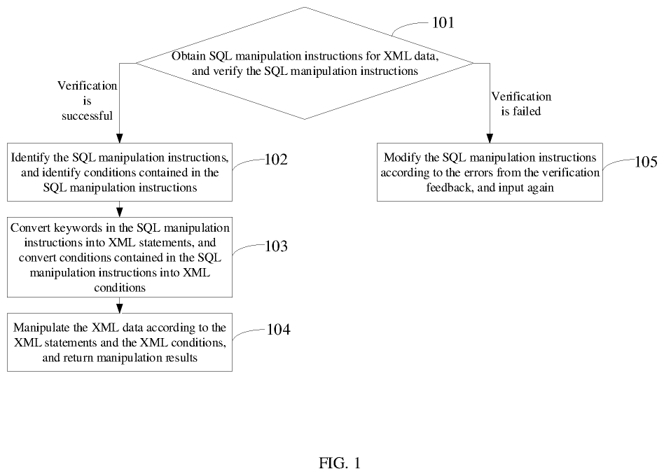

The embodiment of the present disclosure provides a method for manipulating XML data. With reference to FIG. 1, the method includes:

at 101, obtaining SQL manipulation instructions for XML data, and verifying the SQL manipulation instructions; if the verification is successful, perform steps 102-104, otherwise, perform step 105.

Specifically, verifying the SQL manipulation instructions may include:

verifying, according to a grammar engine, whether the SQL manipulation instructions conform to standard SQL manipulation instructions.

At 102, the SQL manipulation instructions are identified, and conditions contained in the SQL manipulation instructions are identified.

Specifically, the processes of identifying the SQL manipulation instructions may include:

identifying manipulation types of the SQL manipulation instructions;

identifying, according to the manipulation types, keywords corresponding to each of the manipulation types; and

performing non-sensitive process on the keywords.

The processes of identifying the conditions contained in the SQL manipulation instructions may include:

determining whether conditional statements exist in the SQL manipulation instructions;

if the conditional statements exist, transform the conditional statements to Reverse Polish Notations;

if not, set the conditional statement to a default value.

At 103, keywords in the SQL manipulation instructions are converted into XML statements, and conditions contained in the SQL manipulation instructions are converted into XML conditions.

The SQL manipulation instructions contain conditional statements. The process of converting the conditions of the SQL manipulation instructions into XML conditions may include:

converting Reverse Polish Notations into XML conditions.

At 104, the XML data is manipulated according to the XML statements and the XML conditions, and manipulation results are returned.

Specifically, manipulation destination data is obtained from the XML data according to the XML conditions.

Manipulate The manipulation destination data is manipulated according to the XML statements, and manipulation results are returned.

At 105, the SQL manipulation instructions are modified according to the errors from the verification feedback, and are input again.

The embodiment of the present disclosure provides a method for manipulating XML data. By converting keywords in the SQL manipulation instructions into XML statements, converting conditions contained in the SQL manipulation instructions into XML conditions, manipulating XML data according to the XML statements and the XML conditions and returning the manipulation results, it is possible to manipulate data in XML format by SQL, and the data stored in XML format can be manipulated conveniently and quickly, improving data manipulation efficiency and facilitating the use of users. As SQL is widely used in relational database systems, and more and more data are stored in XML format because of the convenience of XML format data, by the method provided by the embodiments of the present disclosure, it is possible to manipulate data stored in XML format by SQL, solving the problem of having to manipulate the XML format data in some SQL-used databases. Meanwhile, by identifying the SQL manipulation instructions, identifying the conditions contained in the SQL manipulation instructions, converting the keywords in the SQL manipulation instructions into XML statements, and converting the conditions contained in the SQL manipulation instructions into XML conditions, the manipulation is convenient and quick, and it is possible to manipulate the XML format data by SQL quickly, improving manipulation efficiency and facilitating the use of user. Meanwhile, the embodiments of the present disclosure perform verification on the SQL manipulation instructions before identifying the SQL manipulation instructions and identifying the conditions contained in the SQL manipulation instructions. The verification makes the SQL manipulation instructions conform to the standard SQL instructions, avoiding the problem of lower manipulation efficiency and repeated manipulations caused by the execution error by non-standardized instructions. Thereby data manipulation efficiency is provided, and the use of users is facilitated.

### Embodiment 2

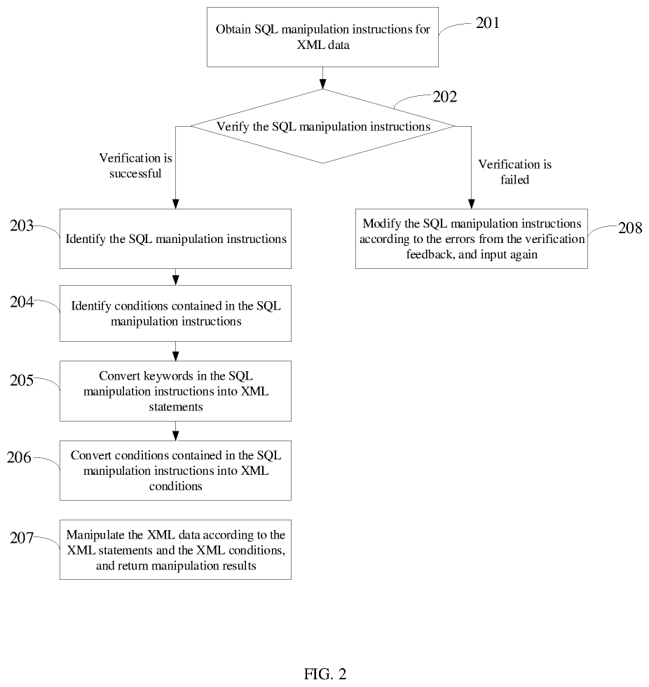

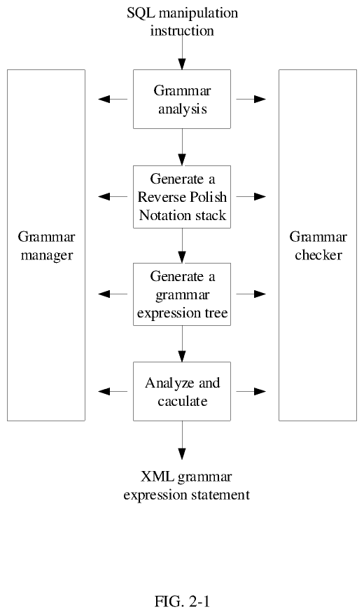

The embodiment of the present disclosure provides a method for manipulating XML data. With reference to FIG. 2, the method includes:

at 201, obtaining SQL manipulation instructions for XML data.

Specifically, the SQL manipulation instructions may include Select instructions, Insert instructions, Update instructions, and Delete instructions, and may also include Return Modification instructions, Copy instructions, and Import and Export Instructions, etc. Other than this, the SQL manipulation instructions may also be other manipulation instructions. The embodiment of the present disclosure does not limit specific SQL manipulation instructions.

The obtaining process may be any one of the following:

obtaining SQL manipulation instructions through an instruction input interface for XML data, the instruction input interface is preconfigured to be able to input SQL manipulation instructions, or obtaining SQL manipulation instructions sent by a third-party application, the destination data of the SQL manipulation instructions being stored in XML format.

At 202, the SQL manipulation instructions are verified. If the verification is successful, perform steps 203-207. Otherwise, perform step 208.

Specifically, whether the SQL manipulation instructions conform to standard SQL manipulation instructions are verified according to a grammar engine. If the verification is successful, perform steps 203-207. Otherwise, perform step 208.

The grammar engine can be preset. The standard SQL manipulation instructions can be customized standard SQL manipulation instructions. The customized SQL manipulation instructions include instructions related to data path description, in addition to the original SQL manipulation instructions.

Specifically, the implementation process of the grammar engine may include:

building a grammar supporting environment and a grammar checker.

The construction of the grammar supporting environment includes the construction for grammar elements. Specifically, grammar elements may include variables, data manipulations, data types, legal operator sets, reserved words, and separators, etc. that are supported by notations.

The implementation process may further include making a unified management by a grammar manager for the grammar elements built.

The purpose of managing the grammar elements is to manage grammar symbols below.

Operator management includes managing all operators supported by the engine, which are built-in operators that can be recognized. Operators have the characteristic of regular symbols, including operator mark strings, operands and operand numbers, etc. Different operators have different manipulation priorities.

Grammar reserved words management is mainly used for storing various keywords, separators etc. which are supported by the notations, and which are parts of the notation structure, such as “order”, “by”.

Variable management mainly manages global variables built in a grammar parsing engine and environmental variables customized by users. The engine needs to be preregistered into the manager.

By the grammar engine above, whether the SQL manipulation instructions conform to the customized standard SQL manipulation instructions is verified. If the verification is not successful, perform steps 203-207. Otherwise, perform step 208.

By verifying the SQL manipulation instructions, the SQL manipulation instructions are made conform to the standard SQL instructions, avoiding the execution error caused by non-standardized instructions and the resulted problem of lower manipulation efficiency and repeated manipulations. Thereby, data manipulation efficiency is provided, and the use of users is facilitated.

At 203, the SQL manipulation instructions are identified.

Specifically, the process may include:

a. identifying manipulation types of the SQL manipulation instructions.

Specifically, the manipulation types may include Select, Insert, Update, and Delete. The identification process may be implemented by identifying a manipulation type keyword in the SQL manipulation instruction.

b. Identifying keywords corresponding to each of the manipulation types according to manipulation types.

Specifically, if it is a Select instruction, keywords such as an object name, a qualification ID, a where condition, a word sorting order, and a sub-query in contained in the Select manipulation type instruction are identified.

If it is an Insert instruction, keywords such as an object name contained in the Insert manipulation type instruction are identified.

If it is an Update instruction, keywords such as an object name, a qualification ID, and a where condition contained in the Update manipulation type instruction are identified.

If it is a Delete instruction, keywords such as an object name, a qualification ID, and a where condition contained in the Delete manipulation type instruction are identified.

Other than this, it may also identify other customized keywords, and the embodiment of the present disclosure does not limit the identification for keywords corresponding with each of the manipulation types.

c. Performing non-sensitive process on the keywords.

Specifically, the non-sensitive process includes unifying the keywords in the SQL manipulation instructions into lowercase.

By unifying the keywords identified into lowercase, it is convenient to convert keywords into XML statements in the following execution steps. Because XML statements are case-sensitive, unifying the keywords identified into lowercase avoids the problem that the instruction manipulated by the converted XML statement is not consistent with the instruction to be manipulated by the keyword itself because of the case of the XML statement after conversion. Thereby data manipulation efficiency is further improved, errors after converting to XML statements are avoided, and the use of users is further facilitated.

At 204, conditions contained in the SQL manipulation instructions ae identified.

Specifically, the process may include:

determining whether conditional statements exist in the SQL manipulation instructions.

if the conditional statements exist, transform the conditional statements to Reverse Polish Notation;

if not, set the conditional statement to a default value.

The process of transforming the conditional statements to Reverse Polish Notations may include:

a. formatting the conditional statement;

b. cutting the conditional statement, pushing the condition into the stack by the principle of last-in-first-out, then converting it into a string array, and

c. transforming the string array to a Reverse Polish Notation.

Setting the conditional statement to a default value includes, for example, when conditional statements do not exist, the default is all, add 1=1 as a condition of being constant true at the same time.

Transforming the conditional statements to Reverse Polish Notations simplifies the process of data processing, and it is able to make a unified transformation to Reverse Polish Notations when multiple conditions are contained. Therefore, there is no need to transform each condition separately. Accordingly, the manipulation procedure is further simplified, and the data processing efficiency is improved.

It should be noted that step 204 may be performed after or before step 203, or steps 203 and 204 can be performed simultaneously. The embodiment of the present disclosure does not limit the specific order of steps 203 and 204.

At 205, keywords in the SQL manipulation instructions are converted into XML statements.

Specifically, the keywords are added to the locations corresponding to standard XML statements, and XML statements are generated.

At 206, conditions contained in the SQL manipulation instructions are converted into XML conditions.

Specifically, the process of converting conditions contained in the SQL manipulation instructions into XML conditions may include:

converting Reverse Polish Notations into XML conditions; the process may be converting Reverse Polish Notations into XML conditions by a preconfigured engine.

The preconfigured engine may be the same engine with the grammar engine in step 202.

If the SQL manipulation instructions do not contain conditional statements, then there is no need to execute step 206.

It should be noted that step 206 may be executed after or before performing step 205, or steps 205 and 206 may be performed simultaneously. The embodiment of the present disclosure does not limit the specific order of steps 205 and 206.

At 207, the XML data is manipulated according to the XML statements and the XML conditions, and manipulation results are returned.

Specifically, manipulation destination data is obtained from XML data according to the XML conditions and a path description. If there are multiple XML conditions or multiple path descriptions, then multiple pieces of manipulation destination data are obtained from XML data. If the SQL manipulation instructions do not include conditional statements, then manipulation destination data is obtained from XML data according to the path description.

The destination data is manipulated according to the XML statements, and manipulation results are returned.

At 208, the SQL manipulation instructions are modified according to the errors from the verification feedback, and are input again.

The embodiment of the present disclosure does not limit the specific process of modifying the manipulation instructions. After the modification is completed, the process from step 201 to step 207 are performed again.

As an example, to further illustrate the method of the embodiment of the present disclosure, FIGS. 2-1 illustrates a text flow diagram showing the process of converting the SQL manipulation instructions into XML statements by the grammar engine.

Further, to illustrate the method provided by the embodiment of the present disclosure, a code segment of the grammar engine generating XML is provided below, specifically as following.

cond2xml(String next) {

String cond = “”;
String regex = “!=”;
if(next.matches(“<[\hat{ }>]+>.*</[\hat{ }>]+>”)){

return next;

}
next = next.replaceAll(“=\\s*null”, “=””);
if (next.split(regex).length == 2) {

String path = “<path>” + next.split(regex)[0] + “</path>”;
String value = “<value>” + next.split(regex)[1]

+ “</value>”;

cond = “<ne>” + path + value + “</ne>”;

}else if (next.split(“>=”).length == 2) {

regex = “>=”;
String path = “<path>” + next.split(regex)[0] + “</path>”;
String value = “<value>” + next.split(regex)[1]

+ “</value>”;

cond = “<ge>” + path + value + “</ge>”;

}else if (next.split(“<=”).length == 2) {

regex = “<=”;
String path = “<path>” + next.split(regex)[0] + “</path>”;
String value = “<value>” + next.split(regex)[1]

+ “</value>”;

cond = “<le>” + path + value + “</le>”;
/////////////////////////////

}else if (next.split(“>”).length == 2) {

regex = “>”;
String path = “<path>” + next.split(regex)[0] + “</path>”;
String value = “<value>” + next.split(regex)[1]

+ “</value>”;

cond = “<gt>” + path + value + “</gt>”;

}else if (next.split(“=”).length == 2) {

regex = “=”;
String path = “<path>” + next.split(regex)[0] + “</path>”;
String value = “<value>” + next.split(regex)[1]

+ “</value>”;

cond = “<eq>” + path + value + “</eq>”;

} else if (next.split(“<”).length == 2) {

regex = “<”;
String path = “<path>” + next.split(regex)[0] + “</path>”;
String value = “<value>” + next.split(regex)[1]

+ “</value>”;

cond = “<lt>” + path + value + “</lt>”;

}else if(next.split(“\\s+like\\s+”).length == 2){

regex = “\\s+like\\s+”;
String path = “<path>” + next.split(regex)[0] + “</path>”;
String value = “<value>” + next.split(regex)[1]

+ “</value>”;

cond = “<like>” + path + value + “</like>”;

}else if (next.split(“in”).length == 2) {

regex = “in”;
String path = “<path>” + next.split(regex)[0] + “</path>”;
String value = “<value>” + next.split(regex)[1]

+ “</value>”;

value = value.replaceAll(“\\(”, “”);
value = value.replaceAll(“\\)”, “”);
cond = “<in>” + path + value + “</in>”;
////////////////////

}
else {

cond = next;

}
return cond;

For example, for the SQL manipulation instruction below:

select**from bookstructure Branch where position code=02 && treeName=tree name && name=branch name new3,

the XML grammar expression converted by the grammar engine above, for, example, may be as following.

<and>

<and>
<eq>

<path>positioncode </path>
<value>02</value>

</eq>
<eq>

<path>treeName</path>
<value>tree name</value>

</eq>

</and>
<eq>

<path>name</path>
<value>branch name new3</value>

</eq>

</and>

The embodiment of the present disclosure provides a method for manipulating XML data. By converting keywords in the SQL manipulation instructions into XML statements, converting conditions contained in the SQL manipulation instructions into XML conditions, manipulating XML data according to the XML statements and the XML conditions and returning the manipulation results, it is possible to manipulate data in XML format by SQL, and the data stored in XML format can be manipulated conveniently and quickly, improving data manipulation efficiency and facilitating the use of users. As SQL is widely used in relational database systems, and more and more data are stored in XML format because of the convenience of XML format data, by the method provided by the embodiments of the present disclosure, it is possible to manipulate data stored in XML format by SQL, solving the problem of having to manipulate the XML format data in some SQL-used databases. Meanwhile, by identifying the SQL manipulation instructions, identifying the conditions contained in the SQL manipulation instructions, converting the keywords in the SQL manipulation instructions into XML statements, and converting the conditions contained in the SQL manipulation instructions into XML conditions, the manipulation is convenient and quick, and it is possible to manipulate the XML format data by SQL quickly, improving manipulation efficiency and facilitating the use of user. Meanwhile, the embodiments of the present disclosure perform verification on the SQL manipulation instructions before identifying the SQL manipulation instructions and identifying the conditions contained in the SQL manipulation instructions. The verification makes the SQL manipulation instructions conform to the standard SQL instructions, avoiding the problem of lower manipulation efficiency and repeated manipulations caused by the execution error by non-standardized instructions. Thereby data manipulation efficiency is provided, and the use of users is facilitated.

### Embodiment 3

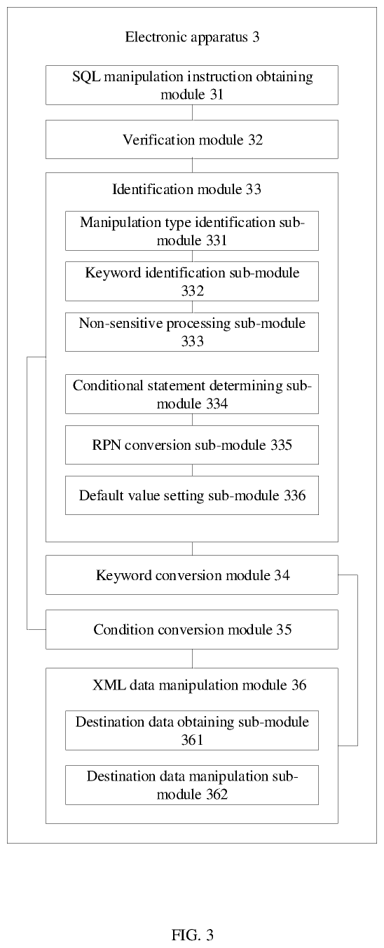

The embodiment of the present disclosure provides an electronic apparatus 3. Referring to FIG. 3, the electronic apparatus includes:

an SQL manipulation instruction obtaining module 31, configured to obtain SQL manipulation instructions for XML data;

a verification module 32, configured to verify the SQL manipulation instructions;

an identification module 33, configured to identify the SQL manipulation instructions and to identify conditions contained in the SQL manipulation instructions, when the verification module is successfully verified;

a keyword conversion module 34, configured to convert keywords in the SQL manipulation instructions into XML statements;

a condition conversion module 35, configured to convert the conditions contained in the SQL manipulation instructions into XML conditions; and

an XML data manipulation module 36, configured to manipulate the XML data according to the XML statements and the XML conditions, and to return manipulation results.

Optionally, the verification module 32 is specifically configured to:

verify, according to a grammar engine, whether the SQL manipulation instructions conform to standard SQL manipulation instructions.

Optionally, the identification module 33 includes:

a manipulation type identification sub-module 331, configured to identify manipulation types of the SQL manipulation instructions;

a keyword identification sub-module 332, configured to identify keywords corresponding to each of the manipulation types according to the manipulation types; and

a non-sensitive processing sub-module 333, configured to perform non-sensitive process on the keywords.

Optionally, the identification module 33 further includes:

a conditional statement determining sub-module 334, configured to determine whether conditional statements exist in the SQL manipulation instructions;

an RPN conversion sub-module 335, configured to transform the conditional statements into Reverse Polish Notations when the conditional statement determining sub-module 334 determines that the conditional statements exist in the SQL manipulation instructions; and

a default value setting sub-module 336, configured to set the conditional statement to a default value when the conditional statement determining sub-module 334 determines that the conditional statements do not exist in the SQL manipulation instructions.

Optionally, the SQL manipulation instructions contain the conditional statements, and the condition conversion module 35 is specifically configured to:

convert the Reverse Polish Notations into XML conditions.

Optionally, the XML data manipulation module 36 includes:

a destination data obtaining sub-module 361, configured to obtain the manipulation destination data from the XML according to the XML condition; and

a destination data manipulation sub-module 362, configured to manipulate the manipulation destination data according to the XML statements, and to return manipulation results.

The embodiment of the present disclosure provides an electronic apparatus. By converting keywords in the SQL manipulation instructions into XML statements, converting conditions contained in the SQL manipulation instructions into XML conditions, manipulating XML data according to the XML statements and the XML conditions and returning the manipulation results, it is possible to manipulate data in XML format by SQL, and the data stored in XML format can be manipulated conveniently and quickly, improving data manipulation efficiency and facilitating the use of users. As SQL is widely used in relational database systems, and more and more data are stored in XML format because of the convenience of XML format data, by the method provided by the embodiments of the present disclosure, it is possible to manipulate data stored in XML format by SQL, solving the problem of having to manipulate the XML format data in some SQL-used databases. Meanwhile, by identifying the SQL manipulation instructions, identifying the conditions contained in the SQL manipulation instructions, converting the keywords in the SQL manipulation instructions into XML statements, and converting the conditions contained in the SQL manipulation instructions into XML conditions, the manipulation is convenient and quick, and it is possible to manipulate the XML format data by SQL quickly, improving manipulation efficiency and facilitating the use of user. Meanwhile, the embodiments of the present disclosure perform verification on the SQL manipulation instructions before identifying the SQL manipulation instructions and identifying the conditions contained in the SQL manipulation instructions. The verification makes the SQL manipulation instructions conform to the standard SQL instructions, avoiding the problem of lower manipulation efficiency and repeated manipulations caused by the execution error by non-standardized instructions. Thereby data manipulation efficiency is provided, and the use of users is facilitated.

From all the optional technical solutions above, any combination may be adopted to form an embodiment of the present disclosure. There will not be more explanations one by one.

It should be noted that: when the apparatus in the embodiment above is performing the manipulation method for XML data, it is only explained as an example by the division of each functional module above. In a practical application, the functions may be assigned and accomplished by different functional modules based on needs; that is, the inner structure of the apparatus is divided into different functional modules to accomplish all the functions or part of the functions described above. In addition, the apparatus provided by the embodiment above has the same idea with the embodiment of the method for manipulating XML data. See the embodiment of the method for the details of the specific implementation process. There will not be details here.

A person of ordinary skilled in the art may understand that all steps or part of the steps of the embodiments may be implemented by hardware, or by the related hardware instructed by programs. The program may be stored in a computer readable storage medium. The storage medium may be ROM, disk or CD, etc.

The above are only the preferred embodiments of the present disclosure, and are not intended to limit the present disclosure. Any modification, equivalent replacement, and improvement, etc. within the spirit and the principle of the present disclosure, are all supposed to be contained in the scope of protection of the present disclosure.

1. A method of manipulating Extensible Markup Language (XML) data, comprising:
obtaining Structured Query Language (SQL) manipulation instructions for XML data, and verifying the SQL manipulation instructions;
when verification is successful, identifying the SQL manipulation instructions, and identifying conditions contained in the SQL manipulation instructions;
converting keywords in the SQL manipulation instructions into XML statements, and converting the conditions contained in the SQL manipulation instructions into XML conditions; and
manipulating the XML data according to the XML statements and the XML conditions, and returning manipulation results.

2. The method of claim 1, wherein verifying the SQL manipulation instructions comprises:
verifying, according to a grammar engine, whether the SQL manipulation instructions conform to standard SQL manipulation instructions.

3. The method of claim 1, wherein identifying the SQL manipulation instructions comprises:
identifying manipulation types of the SQL manipulation instructions;
identifying, according to the manipulation types, keywords corresponding to each of the manipulation types; and
performing non-sensitive process on the keywords.

4. The method of claim 1, wherein identifying conditions contained in the SQL manipulation instructions comprises:
determining whether conditional statements exist in the SQL manipulation instructions;
when the conditional statements exist, transforming the conditional statements into Reverse Polish Notations; and
when the conditional statements do not exist, setting the conditional statement to a default value.

5. The method of claim 4, wherein the SQL manipulation instructions contain the conditional statements, and converting conditions contained in the SQL manipulation instructions into XML conditions comprises:
converting the Reverse Polish Notations into XML conditions.

6. The method of claim 1, wherein manipulating the XML data according to the XML statements and the XML conditions and returning manipulation results comprises:
obtaining manipulation destination data from the XML data according to the XML conditions; and
manipulating the manipulation destination data according to the XML statements, and returning manipulation results.

7. An electronic apparatus, comprising:
an SQL manipulation instruction obtaining module, configured to obtain Structured Query Language (SQL) manipulation instructions for Extensible Markup Language (XML) data;
a verification module, configured to verify the SQL manipulation instructions;
an identification module, configured to identify the SQL manipulation instructions, and to identify conditions contained in the SQL manipulation instructions, when the verification module is successfully verified;
a keyword conversion module, configured to convert keywords in the SQL manipulation instructions into XML statements;
a condition conversion module, configured to convert the conditions contained in the SQL manipulation instructions into XML conditions; and
an XML data manipulation module, configured to manipulate the XML data according to the XML statements and the XML conditions, and to return manipulation results.

8. The apparatus of claim 7, wherein the verification module is specifically configured to:
verify, according to a grammar engine, whether the SQL manipulation instructions conform to standard SQL manipulation instructions.

9. The apparatus of claim 7, wherein the identification module comprises:
a manipulation type identification sub-module, configured to identify manipulation types of the SQL manipulation instructions;
a keyword identification sub-module, configured to identify, according to the manipulation types, keywords corresponding to each of the manipulation types; and
a non-sensitive processing sub-module, configured to perform non-sensitive process on the keywords.

10. The apparatus of claim 7, wherein the identification module further comprises:
a conditional statement determining sub-module, configured to determine whether conditional statements exist in the SQL manipulation instructions;
an RPN conversion sub-module, configured to transform the conditional statements into Reverse Polish Notations, when the conditional statement determining sub-module determines that the conditional statements exist in the SQL manipulation instructions; and a default value setting sub-module, configured to set the conditional statement to a default value, when the conditional statement determining sub-module determines that the conditional statements do not exist in the SQL manipulation instructions.
